(19) United States
(12) Patent Application Publication
(10) Pub. No.: US 2007/0300267 A1
(43) Pub. Date: Dec. 27, 2007

(54) Method and apparatus to facilitate multimedia transfer

(75) Inventor: Jeffrey Jason Griffin, Raleigh, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/474,205

(22) Filed: Jun. 23, 2006

(51) Int. Cl. H04N 5/44; H04N 7/18

(52) U.S. Cl. 725/81; 348/734

(57) ABSTRACT

An electronic device is configured to facilitate the transfer of customized multimedia content. A controller encapsulates multimedia payload using data stored in memory and transfers the encapsulated multimedia content to a remote device over a communications interface. The data may include one or more user-selected start positions for the multimedia content, each being associated with a user-specified predetermined event. The device may also receive encapsulated multimedia content, and use the encapsulated information to update local memory. This allows the receiving electronic device to use the multimedia content as specified by the sending user without requiring the user to redefine the user-selected start positions and their associated predetermined events.

### BACKGROUND

The present invention relates generally to wireless communications devices, and particularly to systems and methods of transferring multimedia content across wireless communications devices.

An increasing number of mobile devices have features that enable a user to enjoy a variety of multimedia content. By way of example, most devices allow users to listen to music, watch video clips, capture and view images, program ring tones, and the like. Some devices additionally permit users to customize this content, and use the customized content to notify the user of an event. One example of such a device is disclosed in U.S. patent application Ser. No. 11/252,152 entitled “A Method and Apparatus for Customizing an Audio File in a Mobile Device,” which was filed on Oct. 15, 2005 and is assigned to the assignee of the present invention. That application is incorporated herein by reference in its entirety. The '152 application discloses a system and method that generates and stores a set of pointers for a stored audio file used as a ring tone. Each pointer identifies a specific user-selected start position for the audio file. Whenever the user receives an incoming call, the device renders the audio file from a start position identified by one of the pointers.

While useful, such methods produce data that is usable only on the device on which the pointers were created. That is, whenever the user wishes to use the customized ring tone or other multimedia content on another device, the user must repeat the process of setting the pointers.

### SUMMARY

The present invention is directed to an electronic device configured to facilitate the transfer of customized multimedia content across devices. In one embodiment, the electronic device comprises a wireless communications device having a communications interface and a controller that executes application logic stored in memory. The controller uses data and information stored in the memory to generate data to encapsulate multimedia content. The information may include one or more user-selected start positions for the multimedia content, and may include identifiers that associate each start position with a user-specified predetermined event. The controller may transmit the encapsulated multimedia content to a remote device over the communications interface.

In another embodiment, the wireless communications device receives the encapsulated multimedia content from a remote device. The controller may validate the received encapsulated multimedia content and, if valid, retrieve the user-selected start positions and associated predetermined event information. The user may accept this information as received, or edit the information as needed. The controller uses this information to update local memory such that a receiving user may use the multimedia content without having to redefine the user-selected start positions and the associated predetermined events.

### BRIEF DESCRIPTION OF THE DRAWINGS

FIG. 1 illustrates a wireless communications device according to one embodiment of the present invention.

FIG. 2 illustrates an exemplary file structure for a multimedia payload according to one embodiment of the present invention.

FIG. 3 is a block diagram illustrating how one embodiment of the present invention might generate the file structure for a multimedia payload.

FIG. 4 illustrates a method by which one embodiment of the present invention generates the file structure for a multimedia payload.

FIG. 5 is a block diagram illustrating how one embodiment of the present invention imports a multimedia payload having the file structure.

FIG. 6 illustrates a method by which one embodiment of the present invention imports a multimedia payload having the file structure.

### DETAILED DESCRIPTION

The present invention is directed to an electronic device configured to permit users to transfer customized multimedia content across devices. In one embodiment, the electronic device generates data that encapsulates a multimedia payload. The data may comprise information and/or executable code, and includes data such as one or more user-selected start positions for the multimedia content. Each start position may further be associated with a type of predetermined event such as an incoming call. Encapsulating the multimedia content facilitates transferring the multimedia content across electronic devices such that a receiving electronic device may use the multimedia content without having to redefine user-selected start positions and predetermined event associations.

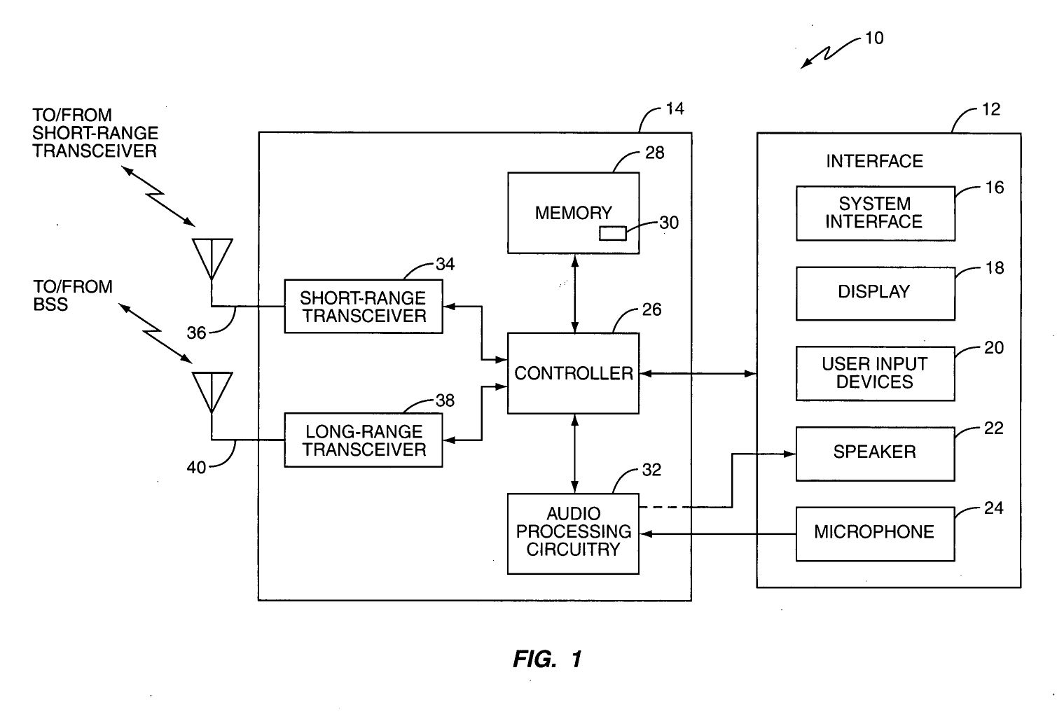

FIG. 1 illustrates a block diagram of an exemplary electronic device configured according to one embodiment of the present invention. In the embodiment of FIG. 1, the electronic device comprises a wireless communications device 10 that permits users to communicate with one or more remote parties via a wireless communications network. However, this is for illustrative purposes only. The electronic device may comprise any known portable electronic device capable of rendering multimedia content. Such devices include, but are not limited to, portable music players, pagers, personal digital assistants (PDA), satellite phones, computing devices, and the like.

Wireless communications device 10 comprises an interface 12 and communications circuitry 14. The interface 12 includes a system interface 16, a display 18, user input devices 20, a speaker 22, and a microphone 24. System interface 16 facilitates the inter-connection of wireless communications device 10 with one or more peripheral devices to permit the transfer of information to and from those devices. Such devices include other wireless communications devices, computing devices, portable music and video players, and the like.

Display 18 may comprise a liquid crystal display (LCD) to enable the user to view menus, images, video, and other information. The user input devices 20 enable a user to interact with and control the wireless communications device 10. The user input devices 20 may comprise any known input devices, such as keypads, touch pads, joystick controls, scroll wheels, and buttons that allow a user to input data and commands. While not specifically shown, a voice recognition system or touch screen display may also be used for user input. Speaker 22 converts analog audio signals into audible signals that can be heard by the user. Microphone 24 converts the detected speech and other audible signals into electrical audio signals for input to controller 26.

The communications circuitry 14 includes a controller 26, memory 28, an audio processing circuit 32, a short-range transceiver 34, and a long-range transceiver 38. Controller 26 controls the overall operation of wireless communications device 10 according to programs stored in memory 28. As described below in more detail, one such program comprises application logic 30. Application logic 30 includes the instructions that permit controller 26 to generate encapsulated multimedia content, and import encapsulated multimedia content. Controller 26 may be implemented as a single processor, or as multiple processors. Suitable processors may include general purpose microprocessors, microcontrollers, digital signal processors, hardware, firmware, or a combination thereof.

Memory 28 represents the entire hierarchy of memory in the wireless communications device 10, and may include both random access memory (RAM) and read-only memory (ROM). Computer programs and data required for operation are stored in non-volatile memory, such as EPROM, EEPROM, and/or flash memory, which may be implemented as discrete devices, stacked devices, or may be integrated with one or more processors. Audio processing circuit 32 provides basic analog output signals to speaker 22, and accepts analog audio inputs from microphone 24.

Short-range transceiver 34 and antenna 36 permit the wireless communications device 10 to communicate signals with other short-range transceivers via a short-range communications link. This allows, for example, a user of the wireless communications device 10 to transmit and receive multimedia content encapsulated according to the present invention over short distances. Short-range transceiver 34 may operate according to standards defined for BLUETOOTH or the IEEE 802.11 family of standards. Alternatively, short-range transceiver may comprise an infra-red port that operates according to any of the Infrared Data Association (IrDA) family of standards.

Long-range transceiver 38 and antenna 40 permits the user to communicate with remote parties via a wireless communications network, and facilitates the transfer of encapsulated multimedia content via the network. Long-range transceiver 38 is a fully functional cellular radio transceiver, which may operate according to any known wireless communication standard, including the standards known generally as the Global System for Mobile Communications (GSM), TIA/EIA-136, cdmaOne, cdma2000, UMTS, and Wideband CDMA.

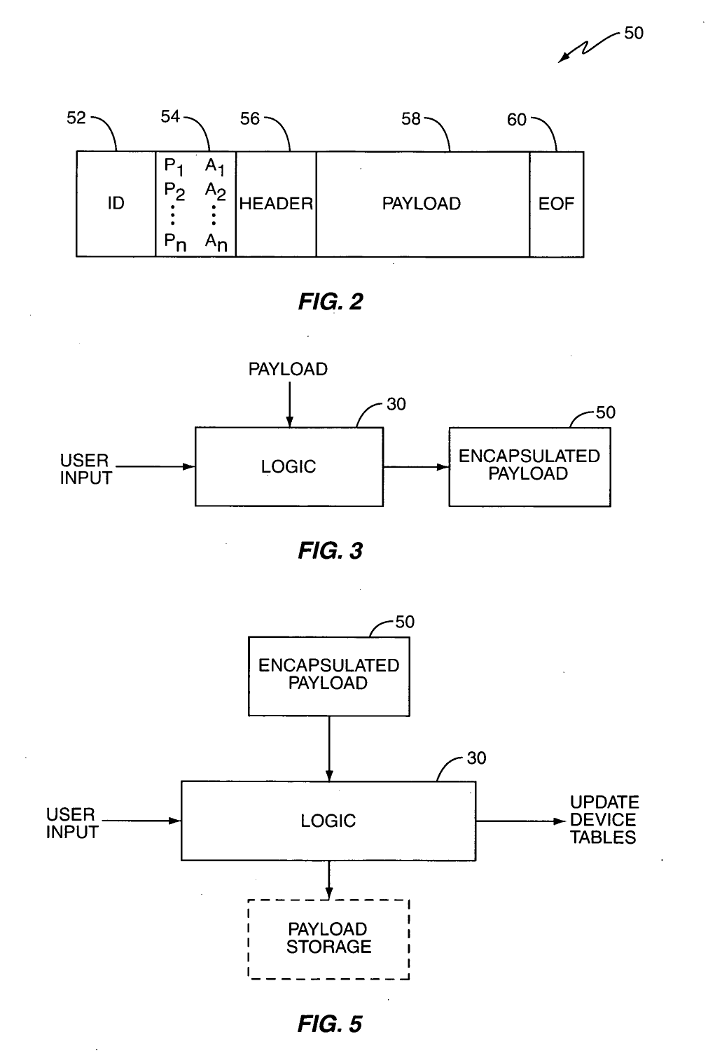

The controller 26 executes application logic 30 to generate and import encapsulated multimedia content. FIG. 2 illustrates an exemplary file format for encapsulating the multimedia content according to one embodiment of the present invention. File 50 comprises an ID section 52, a tag section 54, a header section 56, a payload section 58, and an end-of-file (EOF) marker 60. ID section 52 comprises an indicator that identifies the format of file 50. ID section 52 may include a string of numbers, letters, symbols, or combination thereof that identify file 50 as being formatted specifically for certain manufacturers' devices. Only those devices having application logic 30 capable of reading and interpreting the identified format would be able to render file 50 to the user.

The tag section 54 includes one or more pointers P₁ . . . Pₙ that identify a corresponding number of user-selected start positions for the payload 58. The pointers may comprise, for example, one or more time markers for an audio file such as those generated in co-pending U.S. patent application Ser. No. 11/252,152. Each time marker corresponds to a different user-selected start position for the audio file relative to the beginning of the audio file. Each pointer P₁ . . . Pₙ may further be associated with a given predetermined event A₁ . . . Aₙ. For example, the '152 application noted above permits the user to associate each user-selected starting position with an event such as an incoming call from a particular person, a page, an incoming SMS message, a scheduled event, and the like, and stores this information in memory. Whenever the wireless communications device 10 receives or detects an identified event, the controller 26 plays the audio file from the start position identified by the corresponding pointer.

According to one embodiment of the present invention, the controller 26 operating according to application logic 30 may retrieve the pointers P₁ . . . Pₙ and/or predetermined event information A₁ . . . Aₙ from memory 28, and use this information to generate encapsulated file 50. Upon transfer of the file 50, a receiving wireless communications device 10 able to interpret the specified format could use this information to update its own memory 28. This allows the user of the receiving device to use the pointers P₁ . . . Pₙ and information A₁ . . . Aₙ sent with the file 50, and obviates the need for the user to redefine this information.

Header section 56, which may be part of the payload section 58, includes in some embodiments metadata that identifies information specific to the multimedia content. Such information includes, but is not limited to, the title and author of the multimedia content, the length in bytes, the encoding format, URL(s) that link to a website associated with the multimedia content, and an offset that identifies the beginning of the multimedia content. Where the payload section 58 comprises video or image data, the header section 56 may further include a resolution for display 18.

Payload section 58 comprises the multimedia content that will be rendered to the user. The payload section 58 may comprise video data, image data, audio data, a sequence of instructions to control a tactile function generator associated with the wireless communications device 10, or a combination thereof. The EOF section 60 includes data that identifies the end of encapsulated file 50.

In one embodiment, the ID section 52, tag section 54, header section 56, and EOF section 60 comprise data that is appended to the beginning and end of the payload section 58 during generation of file 50. The data in these fields may be formatted, for example, according to the eXtensible Markup Language (XML). Many known devices are capable of interpreting XML, and therefore, XML facilitates the transfer of the payload 58 between wireless communications devices 10. Because XML and its syntax is well known in the art, only a brief description is included here for clarity.

XML is a text-based language used to describe and apply a hierarchical structure to a variety of data. XML describes data in terms of character data, elements, and attributes of those elements. Each element begins with a start tag and ends with an end tag. The contents of the element are included between the tags. The following line is an example of how the ID section 52 might be generated by wireless communications device 10. In this example, controller 26 generates the XML code that identifies the file 50 as being readable by Sony Ericsson or compatible devices.

<ID>
<file_id>SONYERICSSON</file_id>
</ID>

In this example, the start and end tags are “<file_id>” and “</file_id>,” respectively, while “SONYERICSSON” is the actual indicator. Other elements use similar syntax to define the pointers P₁ . . . Pₙ, predetermined events A₁ . . . Aₙ, and header data in the tag and header sections 54, 56. The following lines are examples of such code.

```
<TAG>
    <ptr_1> 0.5 </ptr_1>
        <assoc_1> “Incoming call 392-0633” </assoc_1>
    <ptr_2> 2.0 </ptr_2>
        <assoc_2> “Incoming email bob @aol.com” </assoc_2>
</TAG>
<HEADER>
    <title> “Enter Sandman” </title>
    <author> Metallica </author>
    <offset> 5 </offset>
</HEADER>
```

In the example above, controller 26 generates the start and end tags <TAG>, </TAG>, <HEADER>, and </HEADER> to identify the beginning and end of the tag and header sections 54, 56, respectively. Within each identified section 54, 56, controller 26 generates the start and end tags and the attributes for those tags accordingly. In this example, each pointer ptr_1, ptr_2, is associated with an identifier that relates a predetermined event to the particular pointer. Controller 26 may retrieve at least some of this information from a users contact list in memory 28.

XML is not the only type of language that may be used to encapsulate the multimedia content. Other languages such as Hypertext Markup Language (HTML) and eXtensible Hypertext Markup Language (XHTML) may also be employed. However, XML is a type of language that permits allows users to create custom start and end tags. Other languages, such as HTML, do not. The flexibility and extensibility that XML therefore provides permits users to add additional elements not specifically mentioned herein to be included in the file 50.

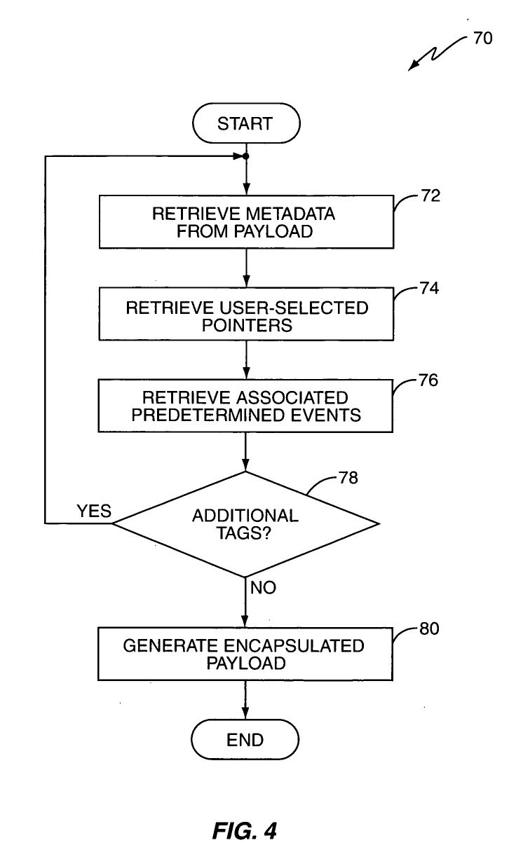

FIGS. 3 and 4 illustrate how the application logic 30 might generate file 50 according to one embodiment. As seen in FIG. 3, the application logic 30 generates file 50 based on the payload (e.g., an audio file) and user input. The user input may be a time marker and predetermined event information entered directly by the user, or retrieved by controller 26 from memory 28.

The method 70 (FIG. 4) begins when the controller 26, operating according to application logic 30, extracts metadata from the multimedia content (box 72). As previously stated, this metadata may include the title and author of the multimedia content as well as other information. Controller 26 also retrieves the pointers (box 74) and the associated predetermined event information (box 76). It should be appreciated that the user may define more than one starting position and/or event for a particular multimedia content, and thus, the controller 26 may repeat the process of gathering data and information as many times as needed or desired (box 78). When the last of the data has been retrieved, the controller 26 generates the file 50 having the format noted in FIG. 2 (box 80). In this embodiment, controller 26 formats the pointer and associated predetermined event information in an XML format, and appends the XML data to the payload section 58, which carries the multimedia content. Controller 26 also formats the ID section 52, the header section 56, and the EOF section 60, and appends those sections to the payload section 58 in a similar manner.

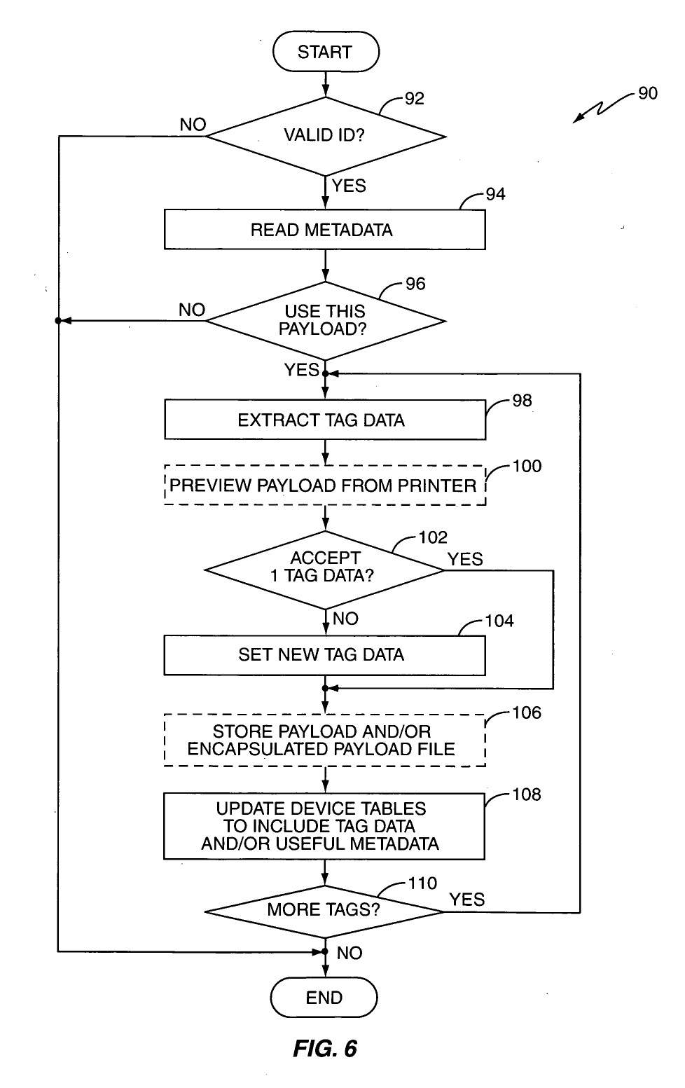

FIGS. 5 and 6 illustrate an embodiment wherein a controller 26, operating according to application logic 30, imports a generated file 50. As seen in FIG. 5, application logic 30 takes file 50 as input and uses the information carried by the sections 52 . . . 56 to update device tables stored in memory 28. Application logic may also prompt the user for input and optionally store the file 50 in memory 28.

A method 90 (FIG. 6) of importing and using the information in file 50 begins when controller 26 determines whether the imported file 50 includes a valid ID in ID section 52 (box 92). This may be accomplished, for example, by comparing the ID in the ID section 52 with one or more valid IDs stored in memory 28. If the ID is not valid, the process ends. If the ID is valid, controller 26 retrieves the metadata from the header section 56 (box 94). The controller 26 may use the metadata information to display the title of the payload 58 to the user, and prompt the user to confirm importing that payload (box 96). Provided the user wishes to import the payload, controller 26 retrieves the pointers P₁ . . . Pₙ and associated predetermined event information A₁ . . . Aₙ from the tag section 54 (box 98).

The controller may then render the payload 58 from the specified starting position (box 100) to allow the user to preview the content. The controller 26 may also display the associated predetermined event information on display 18. The user may accept the retrieved data as-is (box 102), or define a new starting position and/or predetermined event (box 104). The controller 26 may then determine whether the wireless communications device 10 that is importing file 50 already includes the payload section 58 in memory 28, and store the payload section 58 in memory 28 accordingly. The controller 26 may also store the received file 50 in memory 28 to facilitate further dissemination of the file 50 (box 106).

The controller 26 will then use the retrieved information to update the device tables in memory 26 (box 108). For example, where the payload section 58 comprises an audio file used as a ring tone, controller 26 may update the user's address book or other contact list to associate a particular party with the payload section 58 and the starting position. Thereafter, whenever that party calls the user, controller 26 will render the payload section 58 as audio from the specified starting position.

As stated above, the tag section 54 may include a plurality of time markers, each defining a time in seconds relative to a beginning of the multimedia content, and each being associated with a different predetermined event. Therefore, controller 26 may repeat the above process as many times as needed or desired to import this additional data (box 110).

It should be noted that the pointers P₁ . . . Pₙ are not limited to comprising time markers that identify a user-selected start position in time-based units relative to a beginning of the multimedia content. Other embodiments may employ offsets that identify the start positions in terms of bytes relative to a beginning of the multimedia content. Still, other embodiments may use a combination of time markers and offsets. In addition, one or more of the pointers P₁ . . . Pₙ may specify a starting position for the multimedia content relative to the beginning or the end of the multimedia file, or any point in between.

While the present invention has been described in terms of a wireless communications device, the present invention is not so limited. Those skilled in the art will readily appreciate that the present invention may be embodied in a computing device such as a desktop or laptop computer. In such embodiments, the computing device may include logic that permits a user to specify the user-selected start positions for the multimedia content. A controller in the computing device may then generate file 50 as previously described, and transfer the generated file to another electronic device communicatively connected to the computing device. Alternatively, a user may download the file 50 from a remote device over a network, such as the Internet, and store the file 50 for later editing and/or dissemination to remote devices as previously described.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communications device comprising:
a communications interface to communicatively connect the wireless communications device to a remote device;
a memory to store multimedia content;
application logic stored in the memory; and
a controller communicatively connected to the memory and the communications interface, and configured to execute the application logic to:
generate an encapsulated data structure comprising the multimedia content and one or more pointers, each pointer identifying a user-selected start position for the multimedia content; and
transmit the encapsulated data structure to the remote device.

2. The wireless communications device of claim 1 wherein the encapsulated data structure includes an identifier section comprising an indicator that identifies a predetermined format of the encapsulated data structure.

3. The wireless communications device of claim 2 wherein the encapsulated data structure further includes a tag section comprising the one or more pointers.

4. The wireless communications device of claim 3 wherein the tag section further comprises one or more predetermined events, each being associated with a corresponding one of the pointers.

5. The wireless communications device of claim 1 wherein the controller is configured to generate the encapsulated data structure based on information retrieved from a list stored in the memory.

6. The wireless communications device of claim 5 wherein the list comprises a contact list that includes the one or more pointers and an identifier that associates each pointer with a predetermined event.

7. A method of transferring multimedia content between wireless communications devices, the method comprising:
storing multimedia content in a memory of a wireless communications device;
storing one or more pointers in the memory, each pointer identifying a user-selected start position for the multimedia content;
generating an encapsulated data structure including the multimedia content and the one or more pointers; and
transmitting the encapsulated data structure to a remote device communicatively connected to the wireless communications device.

8. The method of claim 7 wherein the generating an encapsulated data structure comprises generating an identifier section to include an indicator that identifies a predetermined format of the encapsulated data structure.

9. The method of claim 8 further comprising generating a tag section to include the one or more pointers.

10. The method of claim 9 further comprising generating the tag section to include an identifier for each pointer, each identifier associating a corresponding pointer to a predetermined event.

11. The method of claim 10 further comprising generating a header section to include data that identifies an encoding scheme of the multimedia content.

12. The method of claim 7 wherein generating an encapsulated data structure comprises generating the encapsulated data structure based on information retrieved from a list stored in the memory of the wireless communications device.

13. The method of claim 12 wherein the list comprises a contact list that includes the one or more pointers, each having an identifier associates the corresponding pointer to a predetermined event.

14. A wireless communications device comprising:
a communications interface to communicatively connect the wireless communications device to a remote device;
a memory;
application logic stored in the memory; and
a controller communicatively connected to the memory and the communications interface, and configured to execute the application logic to:
receive an encapsulated data structure comprising multimedia content and one or more pointers, each pointer identifying a user-selected start position for the multimedia content; and
render the multimedia content beginning from one of the pointers.

15. The method of claim 14 wherein the controller is further configured to update the memory to include the one or more pointers.

16. The wireless communications device of claim 14 wherein the controller is configured to validate the encapsulated data structure responsive to receiving the encapsulated data structure.

17. The wireless communications device of claim 16 wherein the controller is configured to compare an indicator in an identifier section of the encapsulated data structure to a predetermined identifier stored in the memory.

18. The wireless communications device of claim 14 wherein the controller is configured to retrieve the one or more pointers from a tag section of the encapsulated data structure responsive to validating the encapsulated data structure.

19. The wireless communications device of claim 18 wherein the controller is further configured to retrieve one or more identifiers from the tag section, each identifier being associated with a corresponding pointer and comprising information that relates the corresponding pointer to a predetermined event.

20. The wireless communications device of claim 19 further comprising prompting the user to edit at least one of the pointers and the identifiers.

21. The wireless communications device of claim 19 wherein the controller is further configured to update a list stored in the memory to include the pointers and the associated identifiers.

22. The wireless communications device of claim 21 wherein the list comprises a contact list.

23. A method of transferring multimedia content between wireless communications devices, the method comprising:
receiving an encapsulated data structure over a communications interface at a wireless communications device, the encapsulated data structure comprising multimedia content and one or more pointers that identify user-selected start positions for the multimedia content;
validating the encapsulated data structure based on an identifier included with the encapsulated data structure;
retrieving the one or more pointers from the encapsulated data structure based on the validation; and
rendering the multimedia content beginning from a starting point specified by one of the pointers.

24. The method of claim 23 wherein validating the encapsulated data structure comprises comparing an indicator retrieved from an identifier section of the encapsulated data structure to a predetermined identifier stored in the memory.

25. The method of claim 23 further comprising retrieving the one or more pointers from a tag section of the encapsulated data structure.

26. The method of claim 25 further comprising retrieving one or more predetermined events from the tag section, each predetermined event being linked to a corresponding pointer.

27. The method of claim 26 further comprising altering at least one of the pointers and the predetermined event retrieved from the tag section responsive to user input.

28. The method of claim 26 further comprising updating a list stored in the memory to include the pointers and the associated predetermined events.

29. The method of claim 28 wherein the list comprises a contact list.
